(19) United States
(12) Patent Application Publication
(10) Pub. No.: US 2026/0259746 A1
(43) Pub. Date: Sep. 3, 2026

(54) RAPID PROTOTYPING FRAMEWORK FOR DESIGN SYSTEM

(71) Applicant: Charles Schwab & Co., Inc., San Francisco, CA (US)

(72) Inventors: Karthik GOTRALA, Leander, TX (US); Arun Kumar Vedse MALEMANE, Leander, TX (US); Nicky JOSHI, Flower Mound, TX (US); Farzad SHOJA-ASSADI, Dublin, CA (US); Pankaj Madhukar PATIL, Pflugerville, TX (US); Vishu KANDI, Liberty Hill, TX (US)

(73) Assignee: Charles Schwab & Co., Inc., San Francisco, CA (US)

(21) Appl. No.: 19/066,501

(22) Filed: Feb. 28, 2025

Related U.S. Application Data
(60) Provisional application No. 63/560,077, filed on Mar. 1, 2024.

(51) Int. Cl. G06F 9/451; G06F 8/38; G06F 8/41

(52) U.S. Cl. CPC G06F 9/451; G06F 8/38; G06F 8/427

(57) ABSTRACT

A system, apparatus, method, and non-transitory computer readable medium for rapid prototyping framework for design systems may include a computing device configured to receive source code associated with a graphical user interface (GUI) for an application from at least one user, the received source code written in a first format, translate the received source code into object elements of a second format using a parser, generate a document object model (DOM) tree associated with the second format based on the object elements, render the GUI of the application by processing the DOM tree using a execution environment associated with the application, and display the rendered GUI on a display device.

### CROSS-REFERENCE TO RELATED APPLICATIONS

This application claims priority to U.S. Provisional Patent Application No. 63/560,077, filed on Mar. 1, 2024, the entire disclosure of which is incorporated by reference.

### BACKGROUND

### Field

Various example embodiments relate to methods, apparatuses, systems, and/or non-transitory computer readable media providing a rapid prototyping framework for design systems, and more particularly, methods, apparatuses, systems, and/or non-transitory computer readable media providing a rapid prototyping, development, and validation environment for prototyping frameworks for graphical user interfaces (GUI) and/or user experiences (UX) for software applications, web applications, etc.

### Description of the Related Art

Generally, during the development of software applications, web applications, etc. (hereinafter referred to as “applications”), graphics design artists, user interface (UI), and/or user experience (UX) designers, etc., will prototype the graphical elements, e.g., the “look and feel,” of the application using visual design software which output static images of the UI/UX prototype. The image of the UI/UX prototype will be further reviewed and revised by various stakeholders and developers of the application before a final prototype of the UI/UX is finalized and provided as a “design specification” to the software developers of the application.

The software developers will then take the design specification and implement, code, and/or program the UI/UX as part of the source code for the application in a desired format (e.g., a data format, a markup language, a scripting language, a programming language, etc.). However, because the UI/UX designers produce the UI/UX prototype using visual design software, such as Photoshop, Invision, Figma, etc., instead of using the software prototyping resources, software development resources, and/or production environment stack(s) of the production application, certain UI/UX elements used in the design specification may not be available to the software developers implementing the UI/UX in source code and/or the “look and feel” of the UI/UX may be changed, software bugs may appear, etc., due to differences technical differences and/or technical limitations of the format(s) used for software prototyping and/or development of the application, the production environment supporting the application (e.g., for web based applications, etc.), and/or different models of electronic devices used by end users of the software application. Consequently, even after a UI/UX has been finalized, the UI/UX may require further modification and/or revisions later in the product development lifecycle, which may cause further modification to other aspects of the application, such as unintended and/or undesired changes to the underlying logic, unintended and/or undesired changes to the application's resource usage, delays in the development and/or release of the application, etc.

Accordingly, an approach is desired for a software prototyping environment, software development environment, and/or service development framework which provides improved, more efficient, and/or more rapid prototyping of UI/UX designs such that UI/UX designers may be able to generate, validate, and/or modify UI/UX designs quickly and on production software execution stacks and/or production environments, etc.

### SUMMARY

At least one example embodiment is directed towards a computing device.

In at least one example embodiment, the computing device may include a memory storing computer readable instructions, and processing circuitry configured to execute the computer readable instructions to cause the computing device to, receive source code associated with a graphical user interface (GUI) for an application from at least one user, the received source code written in a first format, translate the received source code into object elements of a second format using a parser, generate a document object model (DOM) tree associated with the second format based on the object elements, render the GUI of the application by processing the DOM tree using an execution environment associated with the application, and display the rendered GUI on a display device.

Some example embodiments provide that the computing device is further caused to, receive updates to the source code from the at least one user, update the rendering of the GUI of the application based on the received updates to the source code, and display the updated rendering of the GUI of the application on the display device.

Some example embodiments provide that the computing device is further caused to, perform the updating of the rendering of the GUI of the application in response to receiving the update to the source from the at least one user, and display the updated rendering of the GUI of the application on the display device in response to completion of the updated rendering of the GUI.

Some example embodiments provide that the computing device is further caused to perform the translating of the received source code into the object elements by, identifying web components included in the received source code, the identified web components written in a third format, and translating the identified web components into the second format.

Some example embodiments provide that the computing device is further caused to, traverse each object element included in the DOM tree, the traversing including, determining whether each object element included in the DOM tree is a custom object element, executing custom source code associated with the custom object element to generate a new native object element corresponding to the custom object element based on results of the determination, the custom source code written in the third format, and adding the new native object element to the DOM tree.

Some example embodiments provide that the execution environment is at least one of: a software production environment, a software prototyping environment, a software development environment, a software testing environment, or any combinations thereof.

Some example embodiments provide that the computing device is further caused to, display a software prototyping environment GUI associated with the first format in a first window of the display device, and receive the source code from the at least one user via the software prototyping environment GUI.

Some example embodiments provide that the computing device is further caused to, display the rendered GUI in a second window of the display device, wherein the first window and the second window are displayed on the display device simultaneously.

Some example embodiments provide that the computing device is further caused to perform an audit on the rendered GUI of the application, the audit including at least one of: a performance audit, an accessibility audit, a search engine optimization audit, or any combinations thereof.

Some example embodiments provide that the computing device is further caused to perform the rendering of the GUI of the application using a web browser in communication with the execution environment associated with the application.

At least one example embodiment is directed towards a method of operating a computing device.

In at least one example embodiment, the method may include receiving source code associated with a graphical user interface (GUI) for an application from at least one user, the received source code written in a first format, translating the received source code into object elements of a second format using a parser, generating a document object model (DOM) tree associated with the second format based on the object elements, rendering the GUI of the application by processing the DOM tree using an execution environment associated with the application, and displaying the rendered GUI on a display device.

Some example embodiments provide that the method may further include receiving updates to the source code from the at least one user, updating the rendering of the GUI of the application based on the received updates to the source code, and displaying the updated rendering of the GUI of the application on the display device.

Some example embodiments provide that the rendering of the GUI of the application is updated in response to the receiving of the update to the source from the at least one user, and the updated rendering of the GUI of the application is displayed on the display device in response to completion of the updated rendering of the GUI.

Some example embodiments provide that the translating of the received source code into the object elements further includes, identifying web components included in the received source code, the identified web components written in a third format, translating the identified web components into the second format, and adding additional object elements to the DOM tree corresponding to the identified web components based on the translation of the identified web components.

Some example embodiments provide that the method may further include traversing each object element included in the DOM tree, the traversing including, determining whether each object element included in the DOM tree is a custom object element, executing custom source code associated with the custom object element to generate a new native object element corresponding to the custom object element based on results of the determination, the custom source code written in the third format, and adding the new native object element to the DOM tree.

Some example embodiments provide that the execution environment is at least one of: a software production environment, a software prototyping environment, a software development environment, a software testing environment, or any combinations thereof.

Some example embodiments provide that the method may further include displaying a software prototyping environment GUI associated with the first format in a first window of the display device, and displaying a software prototyping environment GUI associated with the first format in a first window of the display device.

Some example embodiments provide that the method may further include displaying the rendered GUI in a second window of the display device, wherein the first window and the second window are displayed on the display device simultaneously.

Some example embodiments provide that the method may further include performing an audit on the rendered GUI of the application, the audit including at least one of: a performance audit, an accessibility audit, a search engine optimization audit, or any combinations thereof.

Some example embodiments provide that the rendering of the GUI of the application is performed using a web browser in communication with the execution environment associated with the application.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates a system associated with a rapid prototyping, development, and validation environment according to at least one example embodiment;

FIG. 2 illustrates a block diagram of an example computing device associated with the rapid prototyping, development, and validation environment according to at least one example embodiment;

FIG. 3 illustrates a block diagram of an example server associated with the rapid prototyping, development, and validation environment according to at least one example embodiment;

FIG. 4A illustrates an example method for providing the rapid prototyping, development, and validation environment according to at least one example embodiment;

FIG. 4B illustrates an example method for processing a document object model (DOM) tree according to at least one example embodiment;

FIG. 4C illustrates an example JSON configuration tree according to at least one example embodiment;

FIG. 4D illustrates an example DOM tree according to at least one example embodiment;

FIG. 5A illustrates an example editor mode of the GUI for the rapid prototyping, development, and validation environment according to at least one example embodiment;

FIG. 5B illustrates a modification made to the UI/UX of an application using the editor of the GUI according to at least one example embodiment; and

FIGS. 5C to 5F illustrate example preview modes of the GUI for applications generated by the rapid prototyping, development, and validation environment according to at least one example embodiment.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone, a smart device, and/or server, etc., to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

At least one example embodiment is directed to methods, systems, devices, and/or non-transitory computer readable media for providing a rapid software prototyping, software development, and/or validation environment for prototyping frameworks for graphical user interfaces (UI or GUI) and/or user experiences (UX) for software applications, web applications, etc. The example embodiments provide improvement over conventional GUI development and/or prototyping frameworks because it allows for rapid prototyping and validation of GUIs for software and/or web applications in real-time and/or near real-time on software execution environments, such as production environments serving end users of the application, development environments serving software programmers of the application, testing environments serving testers of the application, etc., and/or end user hardware/software, thereby reducing and/or minimizing any technical differences and/or delays caused by differences between conventional UI/UX visual design development software packages and actual production development packages.

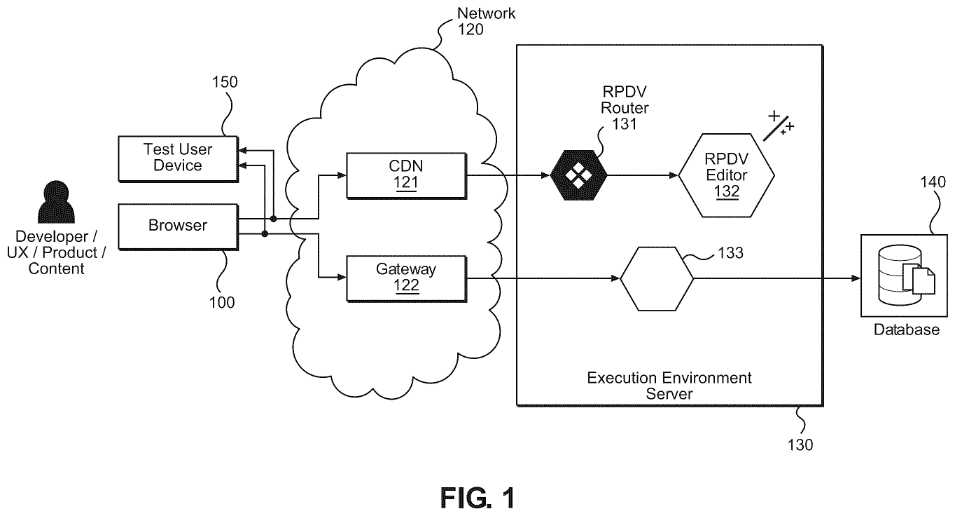

FIG. 1 illustrates a system associated with a rapid prototyping, development, and validation environment according to at least one example embodiment. As shown in FIG. 1, the rapid prototyping, development, and validation (RPDV) environment system includes at least one developer computing device 100 (e.g., a personal computer, a laptop, a workstation, a mobile device, a tablet, etc.), a network 120, and at least one server 130 associated with the RPDV environment, but the example embodiments are not limited thereto, and the example embodiments may include a greater or lesser number of constituent elements.

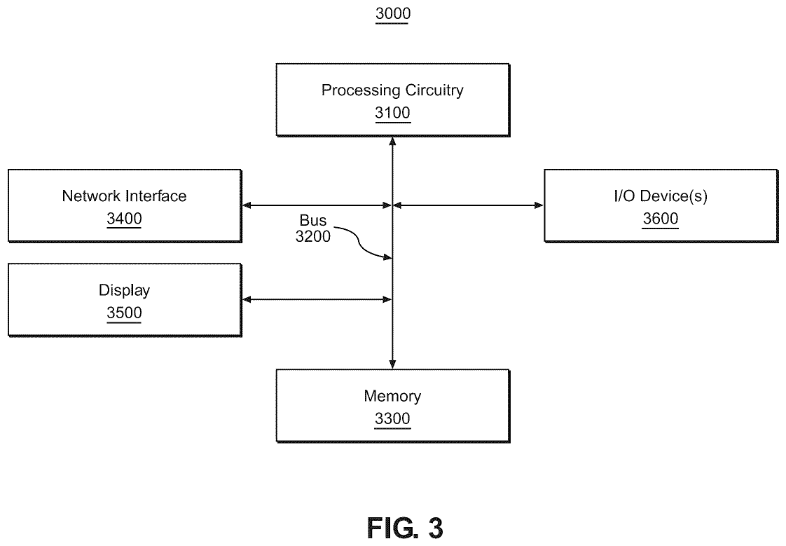

According to at least one example embodiment, the server 130 (e.g., prototyping server, production server, development server, etc.) may host and/or provide functionality associated with the RPDV environment, such as providing at least one source code editor, rapid UI/UX prototyping visualizing system for instantaneously and/or near-instantaneously visualizing changes to UI/UX source code input into the source code editor and/or visualizing the UI/UX source code across a plurality of different end user device types, etc., at least one execution environment software stack (e.g., the software components and/or resources used in the development of the production version/end-user version of the application, the software components and/or resources used in the production version/end-user version of the application, etc.), execution environment network stack (e.g., the servers and/or network related services and resources used for hosting the development version of the production/end-user web applications, the servers and/or network related services and resources used for hosting production/end-user web applications, etc.) to the software developer and/or UI/UX designer, etc., but the example embodiments are not limited thereto, and for example, some functionality may be installed and executed locally by the developer computing device 100, etc. Further, the server 130 may also provide additional validation services, such as automated auditing system, debugging systems, compiling systems, interpreting systems, etc. The server 130 may include a RPDV router 131, RPDV editor 132, RPDV application programming interface (API) 133, etc., but is not limited thereto. Further, according to some example embodiments, the server 130 may include a database server 140 for storing data associated with the RPDV, the source code, objects, and/or resources of the UI/UX and/or application being developed, etc. According to some example embodiments, the server 130, RPDV router 131, RPDV editor 132, RPDV API 133, and/or the database server 140, etc., may be implemented in a single server, or may be implemented as a plurality of servers, etc. The elements of the server 130 and database server 140 will be discussed in greater detail in connection with FIG. 3.

Additionally, the at least one developer computing device 100 may allow a respective UI/UX designer and/or software developer (hereinafter, developer) to access the RPDV environment via the at least one server 130. For example, the at least one developer computing device 100 may have software application(s) (e.g., apps, programs, code, computer readable instructions, etc.) installed and/or may execute native and/or local software application(s) corresponding to the RPDV environment, etc., and/or the at least one developer computing device 100 may have installed and/or may execute a web browser application which allows the developer device to access a web version of the RPDV environment, etc., but the example embodiments are not limited thereto.

According to some example embodiments, additional test user devices 150 may also connect to the RPDV environment, and may include computing devices, such as a personal computer (PC), a laptop, a server, a database system, a smartphone, a tablet, any other smart devices, a wearable device, an Internet-of-Things (IoT) device, a virtual reality (VR) and/or augmented reality (AR) device, a virtual assistant device, a Personal Digital Assistant (PDA), etc., but are not limited thereto. The one or more test user devices may be used to test, validate, and/or debug the prototype UI/UX and/or test logic developed for the application on different hardware devices (e.g., on computers, smartphones, tablets, televisions, etc.) and/or software environments (e.g., iOS native applications, Android native applications, Windows native applications, Linux native applications, web applications on different web browsers, etc.) and/or test different versions of the UI/UX and/or, etc.

The developer user device 100, the test user devices 150, and/or the server 130 may be connected over the network 120, and the network 120 may correspond to a wireless network, such as a cellular wireless access network (e.g., a 3G wireless access network, a 4G-Long Term Evolution (LTE) network, a 5G-New Radio (e.g., 5G) wireless network, a WiFi network, a satellite network, etc.) and/or a wired network (e.g., a fiber network, a cable network, a PTSN, etc.). The server 130 may connect to other servers (not shown), over a wired and/or wireless network, and the network 120 may refer to the Internet, an intranet, a wide area network, etc. According to some example embodiments, the network 120 may include a network gateway 122 for accessing various internal components and/or modules of the server 130 and/or a content delivery network (CDN) 121 for storing and providing cached versions of the RPDV environment, prototype UI/UX and/or prototype software application, etc., to the developer user device 100 and/or the test user devices 150, etc.

While certain components of a system associated with an online trading platform are shown in FIG. 1, the example embodiments are not limited thereto, and the system may include components other than that shown in FIG. 1, which are desired, necessary, and/or beneficial for operation of the underlying networks within the system, such as base stations, access points, switches, routers, nodes, servers, gateways, etc.

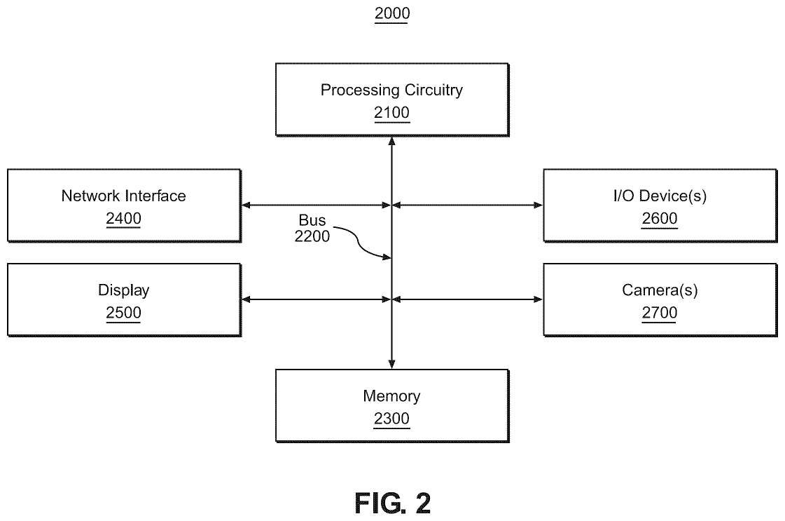

FIG. 2 illustrates a block diagram of an example computing device associated with the rapid prototyping, development, and validation environment according to at least one example embodiment. The computing device 2000 of FIG. 2 may correspond to the developer user device 100 and/or the test user device 150 of FIG. 1, but the example embodiments are not limited thereto.

Referring to FIG. 2, a computing device 2000 may include processing circuitry, such as the at least one processor 2100, at least one communication bus 2200, a memory 2300, at least one network interface 2400, and/or at least one input/output (I/O) device 2600 (e.g., a keyboard, a touchscreen, a mouse, a microphone, a speaker, a scanner, a printer, etc.), etc., but the example embodiments are not limited thereto. For example, the computing device 2000 may further include a display panel 2500, such as a monitor, a touchscreen, etc., and/or a camera 2700 for capturing images, videos, etc. The memory 2300 may include various special purpose program code including computer executable instructions which may cause the computing device 2000 to perform one or more of the methods of the example embodiments, including but not limited to computer executable instructions related to source code written in one or more formats (e.g., programming languages, scripting languages, markup languages, query languages, data formats, etc.) compiling and/or interpreting source code, parsing source, rendering source code, validating an application, auditing an application, debugging an application, etc.

In at least one example embodiment, the processing circuitry may include at least one processor (and/or processor cores, distributed processors, networked processors, etc.), such as the at least one processor 2100, which may be configured to control one or more elements of the computing device 2000, and thereby cause the computing device 2000 to perform various operations. The processing circuitry (e.g., the at least one processor 2100, etc.) is configured to execute processes by retrieving program code (e.g., computer readable instructions) and data from the memory 2300 to process them, thereby executing special purpose control and functions of the entire computing device 2000. Once the special purpose program instructions are loaded into the processing circuitry (e.g., the at least one processor 2100, etc.), the at least one processor 2100 executes the special purpose program instructions, thereby transforming the at least one processor 2100 into a special purpose processor and/or special purpose processing circuitry.

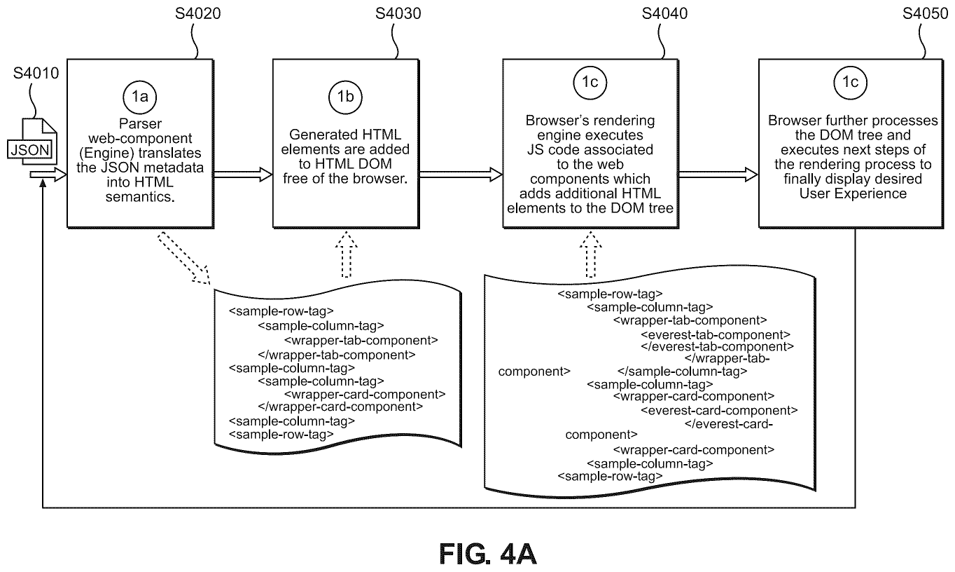

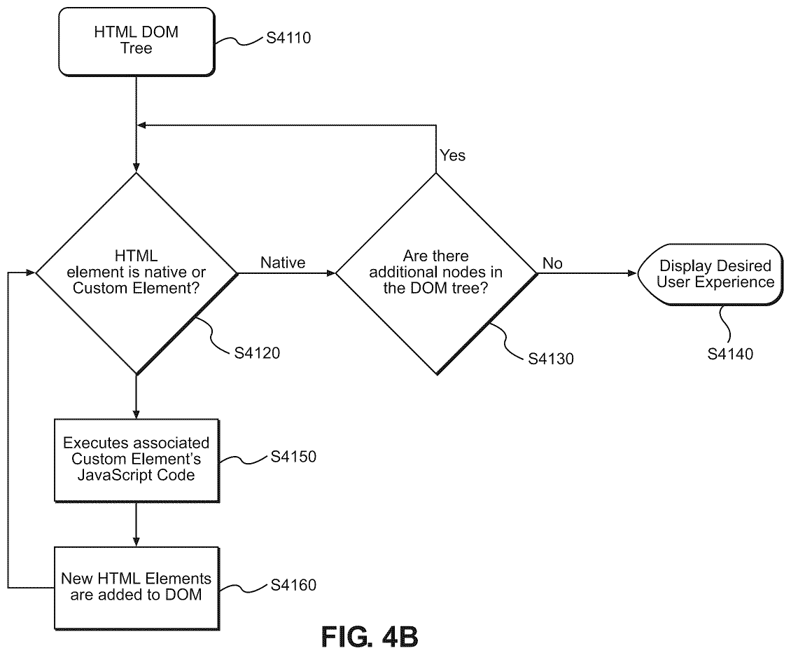

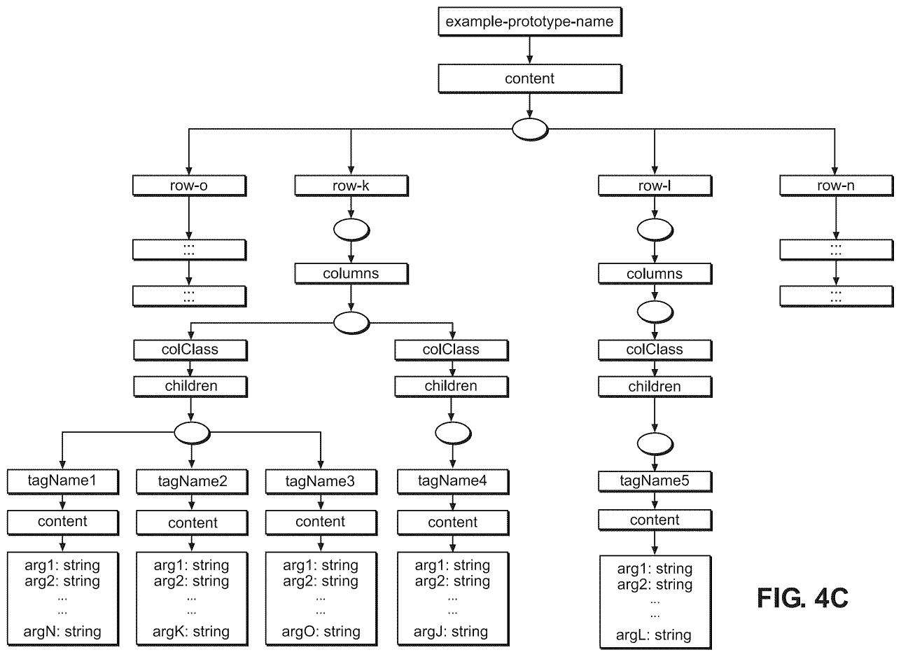

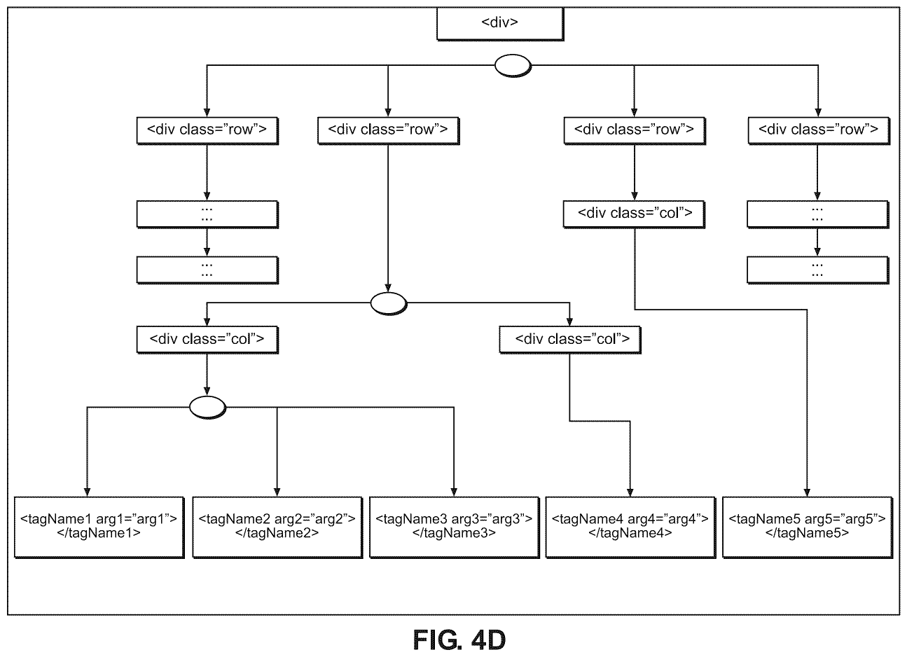

In at least one example embodiment, the memory 2300 may be a non-transitory computer-readable storage medium and may include a random access memory (RAM), a read only memory (ROM), and/or a permanent mass storage device, such as a disk drive and/or a solid state drive, etc. Stored in the memory 2300 is program code (i.e., computer readable instructions) related to operating the RPDV software environment, developing UI/UX, writing source code associated with the application product, and/or the computing device 2000, such as the methods discussed in connection with FIGS. 4A to 4B, the at least one network interface 2400, and/or at least one I/O device 2600, etc. Such software elements may be loaded from a non-transitory computer-readable storage medium independent of the memory 2300, using a drive mechanism (not shown) connected to the computing device 2000, or via the at least one network interface 2400, and/or at least one I/O device 2600, etc.

In at least one example embodiment, the at least one communication bus 2200 may enable communication and/or data transmission to be performed between elements of the computing device 2000. The bus 2200 may be implemented using a high-speed serial bus, a parallel bus, and/or any other appropriate communication technology. According to some example embodiments, the computing device 2000 may include a plurality of communication buses (not shown).

Additionally, the computing device 2000 may also provide a testing environment, validation environment, auditing environment, and/or debugging environment, etc., for the prototype UI/UX and/or application product being developed by the developer. For example, the computing device 2000 may also provide automated auditing software, automated debugging software, compiling software, interpreting software, etc. Further, the computing device 2000 may have various form factors and/or underlying software (e.g., different operating system types, different operating system versions, different software applications installed, different web browsers installed, different sized and/or different types of display screens, different I/O devices connected and/or installed, etc.) which may be used to validate and/or debug the prototype UI/UX and/or prototype software application being developed. The operation of the computing device 2000 and the RPDV software environment, etc., will be discussed in greater detail in connection with FIGS. 4A to 4B.

While FIG. 2 depicts an example embodiment of a computing device 2000, the computing device 2000 is not limited thereto, and may include additional and/or alternative architectures that may be suitable for the purposes demonstrated. For example, the functionality of the computing device 2000 may be divided among a plurality of physical, logical, and/or virtual server and/or computing devices, network elements, etc.

FIG. 3 illustrates a block diagram of an example server associated with the rapid prototyping, development, and validation environment according to at least one example embodiment. The server 3000 of FIG. 3 may correspond to the server 130 and/or database server 140, but the example embodiments are not limited thereto.

Referring to FIG. 3, a server 3000 may include processing circuitry, such as the at least one processor 3100, at least one communication bus 3200, a memory 3300, at least one network interface 3400, and/or at least one input/output (I/O) device 3600 (e.g., a keyboard, a touchscreen, a mouse, a microphone, a camera, a speaker, etc.), etc., but the example embodiments are not limited thereto. For example, the server 3000 may further include a display panel 3500, such as a monitor, a touchscreen, etc. The memory 3300 may include various special purpose program code including computer executable instructions which may cause the server 3000 to perform one or more of the methods of the example embodiments, including but not limited to computer executable instructions related to hosting and/or providing a RPDV environment, providing at least one editor, providing a rapid UI/UX prototyping visualizing system for visualizing changes to UI/UX source code input into the editor and/or visualizing the UI/UX source code across a plurality of different end user device types, etc., at least one execution software stack, providing at least one execution network stack to the software developer and/or UI/UX designer, etc., but the example embodiments are not limited thereto. Additionally, the server 3000 may also provide additional validation services, such as automated auditing system, debugging systems, compiling systems, interpreting systems, etc. The server 3000 may also be a database for storing UI/UX components, source code for application products, machine code for application products, resources, data, content, images, etc., but the example embodiments are not limited thereto.

In at least one example embodiment, the processing circuitry may include at least one processor (and/or processor cores, distributed processors, networked processors, etc.), such as the at least one processor 3100, which may be configured to control one or more elements of the server 3000, and thereby cause the server 3000 to perform various operations. The processing circuitry (e.g., the at least one processor 3100, etc.) is configured to execute processes by retrieving program code (e.g., computer readable instructions) and data from the memory 3300 to process them, thereby executing special purpose control and functions of the entire server 3000. Once the special purpose program instructions are loaded into the processing circuitry (e.g., the at least one processor 3100, etc.), the at least one processor 3100 executes the special purpose program instructions, thereby transforming the at least one processor 3100 into a special purpose processor and/or special purpose processing circuitry.

In at least one example embodiment, the memory 3300 may be a non-transitory computer-readable storage medium and may include a random access memory (RAM), a read only memory (ROM), and/or a permanent mass storage device, such as a disk drive, a solid state drive, etc. Stored in the memory 3300 is program code (i.e., computer readable instructions) related to operating the RPDV environment and/or the server 3000, such as the methods discussed in connection with FIGS. 4A to 4D, the at least one network interface 3400, and/or at least one I/O device 3600, etc. Such software elements may be loaded from a non-transitory computer-readable storage medium independent of the memory 3300, using a drive mechanism (not shown) connected to the server 3000, or via the at least one network interface 3400, and/or at least one I/O device 3600, etc.

In at least one example embodiment, the at least one communication bus 3200 may enable communication and/or data transmission to be performed between elements of the server 3000. The bus 3200 may be implemented using a high-speed serial bus, a parallel bus, and/or any other appropriate communication technology. According to some example embodiments, the server 3000 may include a plurality of communication buses (not shown).

The server 3000 may be associated with a RPDV environment and may be configured to provide functionality related to the RPDV router 131, RPDV editor 132, RPDV application programming interface (API) 133, etc. The RPDV router 131 may host a translated and/or processed version of the application source code, which may include source code of one or more formats (e.g., one or more programming languages, scripting languages, markup languages, query languages, language-independent data formats, etc., or any combinations thereof), web resources and/or assets, etc., and may be served by the RPDV router 131 to the web browser 100 upon request. Once the translated and/or processed version of the application source code is loaded into the web browser 100, the web browser 100 may transmit a command related to an operation mode of the RPDV environment, e.g., an editor mode, a preview mode, etc., to the RPDV router 131 and the corresponding view is provided to the web browser 100. In response to the selected operation mode being the editor mode, the RPDV editor 132 provides the web browser 100 with a format editor (e.g., a source code editor, etc.) which allows the user to create, modify, delete, etc., the configuration of the UI/UX of the application in a first GUI window of the RPDV editor 132, while simultaneously viewing and/or experiencing the changes made to the configuration of the UI/UX of the application in a second GUI window of the RPDV editor 132 in real-time or near real-time. Further, when the preview mode is selected, the configuration of the (updated) UI/UX of the application may be viewed in an execution and/or live environment, thereby allowing the UI/UX developer to instantaneous and/or near instantaneously observer the “touch and feel” of the UI/UX experience similar to and/or the same as the production environment would be for the end user.

Additionally, the RPDV API 133 exposes endpoints, e.g., HTTPS endpoints, etc., for the application to allow the configuration of the UI/UX of the application to be created, modified, and/or deleted by the user and transfer/save/store the updated configuration of the application to the database 140. The saved configuration may be retrieved from the database 140 upon request and further updated by the developer through the RPDV editor 132, previewed using the RPDV router 131, etc.

While FIG. 3 depicts an example embodiment of a server 3000, the server 3000 is not limited thereto, and may include additional and/or alternative architectures that may be suitable for the purposes demonstrated. For example, the functionality of the server 3000 may be divided among a plurality of physical, logical, and/or virtual server and/or computing devices, network elements, etc.

FIG. 4A illustrates an example method for providing the rapid prototyping, development, and validation environment according to at least one example embodiment. FIG. 4B illustrates an example method for processing a document object model (DOM) tree according to at least one example embodiment. FIG. 4C illustrates an example JSON configuration tree according to at least one example embodiment. FIG. 4D illustrates an example DOM tree according to at least one example embodiment.

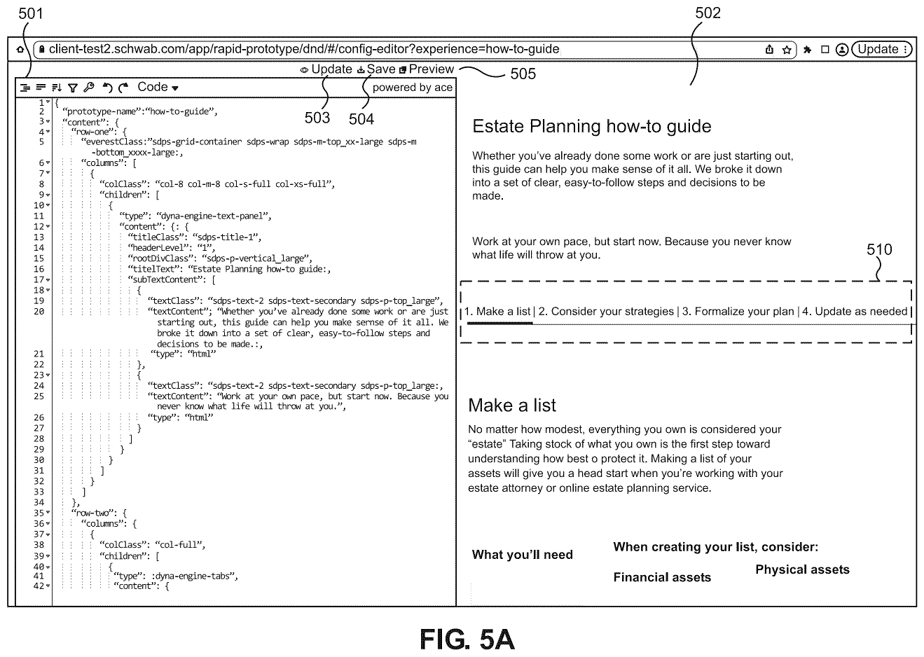

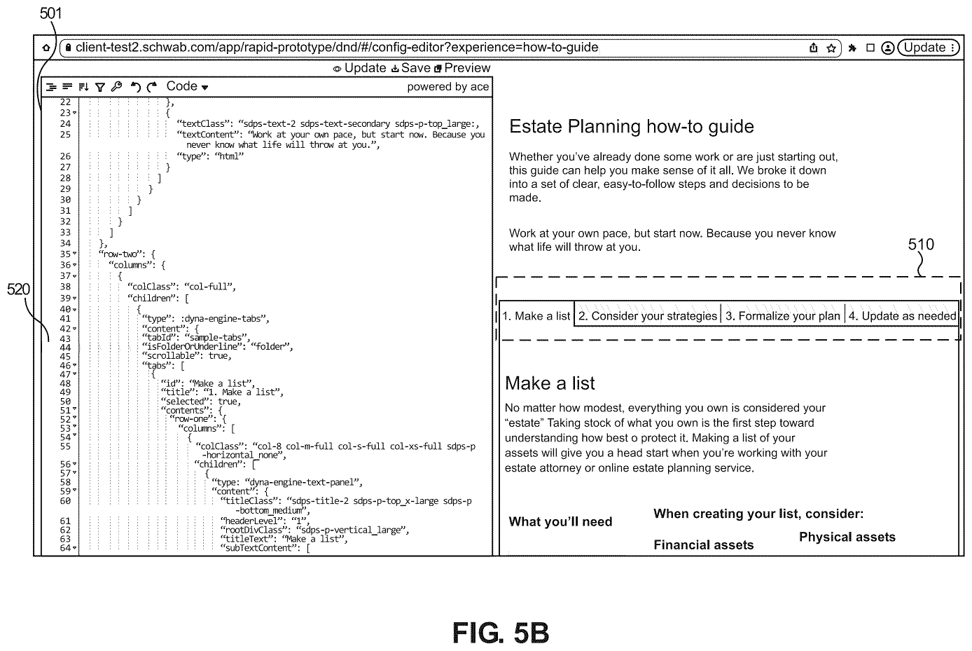

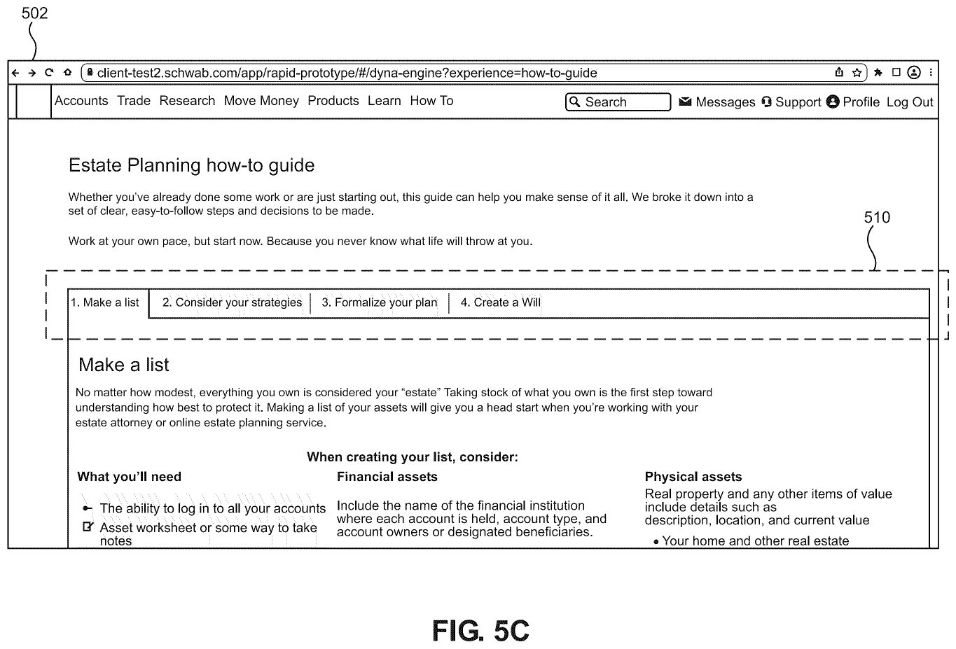

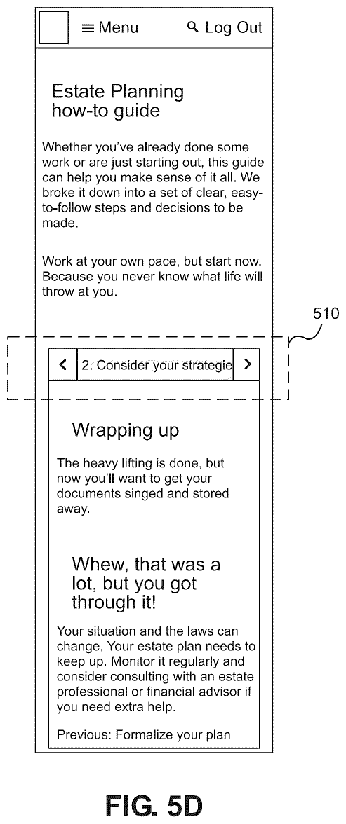

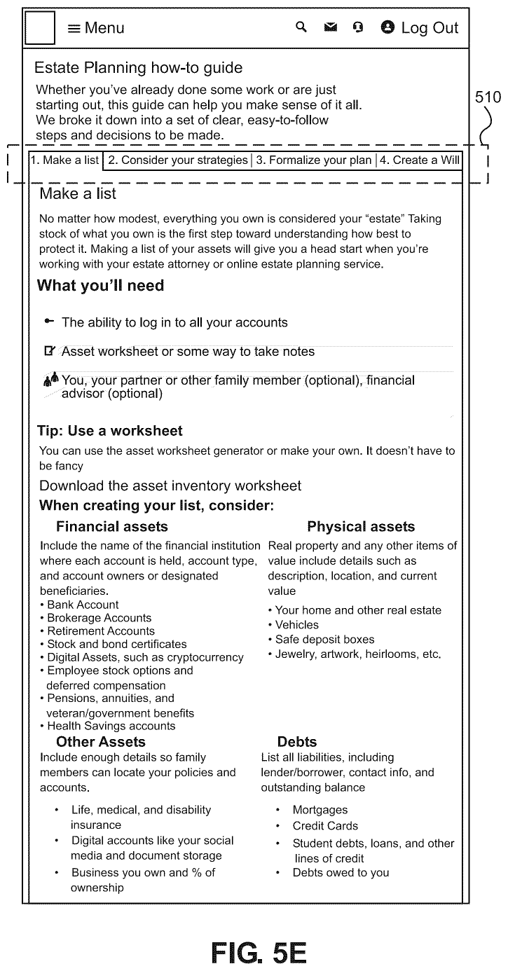

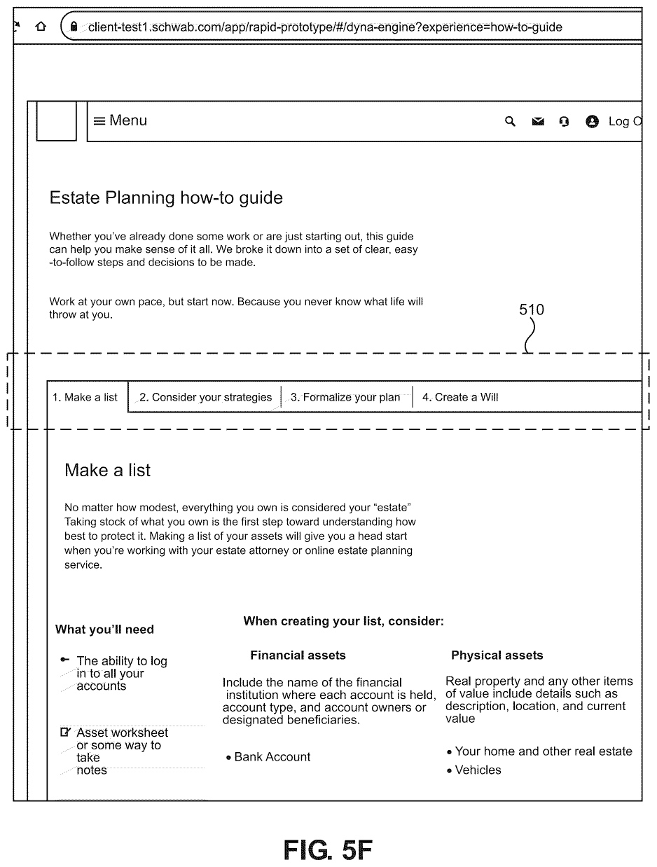

While the example embodiments described in relation to FIGS. 4A to 5C are directed towards a web application initially written in JSON and translated into a HTML document for display on a web browser, the example embodiments are not limited thereto, and may equally be applied to native and/or local software applications written in other formats (e.g., other data format languages, other markup languages, other query languages, other scripting languages, other programming languages, etc.) and/or translated into different formats, etc.

Referring now to FIG. 4A, according to at least one example embodiment, in operation S4010, a developer (e.g., a UI/UX designer, a software developer, etc.), may write, program, and/or otherwise generate source code written in a first data format, programming language, scripting language, markup language, database query language, etc., (collectively referred to herein as “format”) corresponding to a prototype, development version, and/or production version of a software and/or web application, etc. (e.g., application). The source code for the application may further include UI and/or UX elements and/or components, such as styling, typography, spacing, web-components, cascading style sheets (CCS) elements, audio-video content, written content and/or data, database (e.g., SQL, etc.) queries and/or calls, Javascript elements, etc., but the example embodiments are not limited thereto. The developer may input the source code using a RPDV editor (e.g., a software prototyping environment, a software development editor, a software development environment, a software validation environment, a software developer kit, a text editor, etc.) as shown and discussed in greater detail in connection with FIG. 5A. According to at least one example embodiment, the source code may be a JSON tree, such as the example JSON tree shown in FIG. 4C, but the example embodiments are not limited thereto. The RPDV editor may be implemented as a graphical programming interface associated with one or more formats, and may include at least one validation-type feature, such as a compiler and/or interpreter corresponding to a desired format, a software debugger, a software auditing system configured to audit the application for performance (e.g., page load time, memory usage, processor usage, etc.), accessibility (e.g., determining whether the application is accessible to the blind or deaf, etc.), progressive web applications, search engine optimization (SEO), etc., a manual and/or automated validation system, etc. The source code may be stored (e.g., saved) in a database, such as database 140, etc.

According to some example embodiments, the first format may be a language-independent data-interchange format such as Javascript Object Notation (JSON), Yet Another Markup Language (YAML), etc., but the example embodiments are not limited thereto, and for example, may be a programming language such as C/C++/C#, Java, Visual Basic, etc., a scripting language such as Javascript, PHP, Perl, Python, Ruby, etc., a query language such as SQL, etc., a markup language and/or style sheet language such as HTML, XML, CSS, etc.

The developer may access the RPDV editor via the execution environment server 130 using a web browser installed on the developer computing device 100 and/or may have the RPDV editor locally installed and executing on the developer computing device 100, etc.

Further, the RPDV editor may include a visual UI/UX editing component, such as an image editing tool, a what-you-see-is-what-you-get (WYSIWYG) builder, etc., for creating visual elements of the UI/UX of the application.

In operation S4020, the source code written in the first format is passed to a parser engine (e.g., parser web-component, etc.) of, for example, the developer's web browser, e.g., web browser 100, etc., via the RPDV router 131. The parser engine will parse and translate, compile, interpret, etc., the source code written in the first format, e.g., written as a JSON configuration tree, etc., into a second format, for example, e.g., a DOM tree and/or HTML code based on the DOM tree for web applications, etc., but the example embodiments are not limited thereto, and for example, the parser engine may parse and translate, compile, interpret, etc., the source code written in the first format into a second format, such as Java for native Android apps, etc. For example, the parser engine may parse and translate the JSON configuration tree of FIG. 4C into a HTML-based document object model (DOM) tree associated with the UI/UX of the application as shown in FIG. 4D, but the example embodiments are not limited thereto. In operation S4030, a rendering engine, such as a rendering engine of the web browser 100 in the event that the application is a web application, etc., will traverse the translated source code to identify discrete elements within the translated source code and add the elements written in the second format (e.g., translated elements) to the DOM tree associated with the UI/UX of the application.

As shown in FIG. 4C, a JSON configuration tree may include a plurality of nodes (e.g., leaves) arranged on different levels of the tree structure. For example, the JSON tree shown in FIG. 4C includes a first level including one or more attributes associated with the prototype, such as a first attribute (e.g., a name attribute, etc.) containing the name of the prototype and/or a second attribute (e.g., a data attribute, etc.) containing the browser tree data (e.g., the content and/or data associated with the JSON tree, a URL, link, and/or pointer to the content of the JSON tree, etc.), but is not limited thereto, and for example, there may be additional and/or different attributes included in the JSON tree. On the following one or more levels, the JSON tree may include nodes (e.g., leaves) corresponding to one or more UI/UX elements of the application. For example, if the UI/UX follows a “grid” format type, the nodes may correspond to different rows and/or columns of the UI/UX grid. While the UI/UX of the example embodiments is assumed to use a “grid” format type, the example embodiments are not limited thereto, and other UI/UX format types may be implemented.

Next, the parser engine may iterate through all of the row nodes where each row node is translated into, e.g., a HTML div tag with associated row grid styling available in the corresponding node object, etc., as shown in the example DOM tree of FIG. 4D. Similarly, the parser engine iterates through column objects associated with each row and translates the column objects into, e.g., HTML div tags with column grid styling, and inserts the column HTML div tags inside the associated row HTML div tag as shown in the example DOM tree of FIG. 4D. The column objects may further contain one or more leaf-nodes where each leaf-node includes details of tag names and/or identifiers of a component for the column object and associated metadata for the column object. The parser engine may translate the column object nodes into, e.g., HTML elements, using the provided identifier. Additionally, the parser engine may insert the HTML elements inside the associated column HTML div tag to which the column node belongs. The leaf-node may refer to a wrapper component and/or a parser web-component. The parser engine may iteratively process the JSON config tree until all of the nodes of the JSON config tree are processed and will add the node elements to the DOM tree.

In operation S4040, the rendering engine will process each node of the DOM tree to determine if there are any custom elements (in contrast to a native element available through the resources, web components, etc., of the RPDV API 133, etc.) of the UI/UX of the application included in the DOM tree, e.g., UI/UX elements which are not available on the execution environment server 130, RPDV API 133, etc., such as custom fonts, custom images, custom content, custom Javascript code, custom database query, etc. For example, the custom element may be a script, a query, etc., which the rendering engine will execute to generate a custom font, custom image, custom content, etc., translate the custom element into the second format, and add the translated custom element as a new native element in the DOM tree for the application.

In operation S4050, the rendering engine will process the DOM tree to generate and display the UI/UX of the application, etc. According to some example embodiments, the developer may configure various test settings related to the application, such as designating a form factor (e.g., screen size, screen type, etc.) associated with one or more user devices expected to execute the application, configure the computing resources (e.g., processing resources, memory resources, network resources, etc.) available on the one or more user devices expected to execute the application, the operating system executing on the one or more user devices expected to execute the application, etc.

For example, the generated UI/UX may be displayed in a visualization window of the RPDV editor 132 on the developer computing device 100, but is not limited thereto. For example, the generated UI/UX may be displayed on the test user device 150, etc. As another example, a plurality of users, each on a separate developer computing device 100, may view the generated UI/UX for the same at the same time, and in particular, a first user may view the generated UI/UX in the visualization window of the RPDV editor 132 on a first developer computing device 100, and a second user may edit the UI/UX using the RPDV editor 132 on a second developer computing device 100, etc.

According to some example embodiments, because the UI/UX of the application was generated using the second format (e.g., the markup language, scripting language, query language, and/or programming language to be used for developing the production version of the application) using the resources available on a production server, etc., the UI/UX and/or changes to the UI/UX may be viewed in real-time and/or near real-time and validated directly on production hardware and/or development hardware, tested for software bugs, audited, etc., but is not limited thereto. Further, the developer may edit the UI/UX by making changes, revisions, and/or updates to the source code written in the first format using the RPDV editor (e.g., S4010), and the changes will be processed through the parser engine and/or the rendering engine (e.g., S4020, S4030, S4040, and/or S4050) in response to the developers edits. In other words, when the developer writes, changes, and/or refreshes the source code, the RPDV environment will process and render the source code in real-time and/or near real-time, thereby allowing the developer to visualize the effects of the changes to the UI/UX of the application in real-time and/or near real-time. Alternatively, or additionally, the UI/UX of the application may be rendered on request, e.g., when the developer selects a preview mode, etc. Further, according to some example embodiments, another user, such as a second developer, a UI/UX designer, a UI/UX validator, a UI/UX tester, etc., may also view the UI/UX and/or changes to the UI/UX in real-time and/or near real-time using a second user device (e.g., the test user device 150, etc.) connected to the RPDV environment.

However, the example embodiments are not limited thereto, and for example, various operations of the method described in connection with FIG. 4A may be omitted, performed in a different sequence, performed in parallel, etc. Additionally, according to some example embodiments, the parser engine and/or the rendering engine may receive metadata generated by the RPDV editor indicating which nodes of the JSON tree and/or the DOM tree are new and/or have been modified, and the parser engine and/or the rendering engine may only traverse and analyze the new and/or modified JSON tree and/or DOM tree nodes instead of traversing and analyzing the entire JSON tree and/or DOM tree.

Referring now to FIG. 4B, in operation S4110 a rendering engine receives the DOM tree generated by the parser engine, such as the example DOM tree of FIG. 4D, and begins traversing the DOM tree to analyze each DOM tree node.

In operation S4120, the rendering engine determines whether the current DOM tree node corresponds to a native element or a custom element. If the rendering engine determines that the current DOM tree node is a native element, e.g., the resources (e.g., code, font, image, content, etc.) associated with the current DOM tree node are already stored and/or available in the RPDV API 133, the execution environment server 130, and/or database server 140, etc., in operation S4130, the rendering engine determines whether there are any additional nodes in the DOM tree that have not been processed. If there are additional nodes that are unprocessed, the rendering engine moves to the next unprocessed node of the DOM tree and returns to operation S4120. If the rendering engine determines that there are no additional unprocessed nodes in the DOM tree, in operation S4140, the rendering engine translates the processed DOM tree into the desired second format (e.g., HTML code, etc.) to generate the prototype application and outputs the prototype application, e.g., the visualization of the UI/UX of the application, etc., developer computing device 100 and/or the test user device 150, etc., such that the prototype application is displayed on the screen of the developer computing device 100 and/or the test user device 150, etc.

Returning to operation S4120, in the event that the rendering engine determines that the current DOM tree node is a custom element (e.g., a resource which is not already stored and/or available in the RPDV API 133, the execution environment server 130, and/or database server 140, etc.), in operation S4150, the rendering engine will execute the executable custom element to generate a new native element. For example, if the custom element is Javascript code, the rendering engine will execute the Javascript code to generate one or more new HTML element(s) and/or one or more new DOM tree nodes, and move to operation S4160, wherein the one or more new HTML element(s) is/are added to the DOM tree node. According to some example embodiments, the one or more new DOM tree nodes may include one or more custom elements, and the rendering engine may return to operation S4120 for processing of the new DOM tree nodes.

However, the example embodiments are not limited thereto, and for example, various operations of the method described in connection with FIG. 4B may be omitted, performed in a different sequence, performed in parallel, etc.

FIG. 5A illustrates an example editor mode of the GUI for the rapid prototyping, development, and validation environment according to at least one example embodiment. FIG. 5B illustrates a modification made to the UI/UX of an application using the editor of the GUI according to at least one example embodiment. FIGS. 5C to 5F illustrate example preview modes of the GUI for applications generated by the rapid prototyping and validation environment according to at least one example embodiment.

As illustrated in FIG. 5A, a GUI for the RPDV in an editor mode (e.g., a split-view mode, etc.) may include a first window 501 and a second window 502, but is not limited thereto. The first window 501 may display the RPDV editor and source code associated with an application being developed and the second window 502 may display a preview image of the UI/UX of the application based on the source code in the RPDV editor. The preview of the UI/UX of the application shown in the second window 502 may be updated in real-time or in near real-time based on changes made to the source code by the developer, but the example embodiments are not limited thereto, and for example, the preview of the UI/UX of the application may be updated in response to a request by the developer, such as clicking on the update button 503, etc. Additionally, the developer may save the source code to the database of the RPDV through the GUI of the RSDSV by, e.g., selecting the save button 504. Further, the developer may activate a preview mode of the GUI by, e.g., selecting the preview button 505, but is not limited thereto.

As illustrated in FIG. 5B, in comparison to FIG. 5A, the developer may edit the source code using the RPDV editor displayed in the first window 501 to make changes to the UI/UX of the application, by for example, adding a “folder” element 520 to the source code, but the example embodiments are not limited thereto. As shown in FIG. 5B, the row of tabs 510 may be enclosed in a folder element in contrast to the row of tabs 510 in FIG. 5A.

As illustrated in FIGS. 5C to 5F, if the developer selects the preview mode, the first window 501 containing the RPDV editor is closed and the second window 502 is displayed in a full screen mode, thereby allowing the developer to view the UI/UX of the application on their entire display. Further, the developer may change one or more settings of the RPDV such that the UI/UX of the application is visualized in accordance with the display specification of different device types (e.g., different smartphone models, different tablet models, different web browser types, different operating systems, etc.), different display orientations (e.g., landscape mode, portrait mode, etc.), and/or different display screen sizes, etc., thereby allowing the developer to determine whether the UI/UX behaves appropriately across all use cases (e.g., different client devices, operating systems, and/or web browsers, etc.) and quickly and efficiently make edits to the source code. For example, FIG. 5C illustrates the preview image of the UI/UX of FIG. 5B when displayed on a desktop computer, FIG. 5D illustrates the preview image of the UI/UX of FIG. 5B when displayed on a smartphone in portrait mode, FIG. 5E illustrates the preview image of the UI/UX of FIG. 5B when displayed on a tablet in portrait mode, and FIG. 5F illustrates the preview image of the UI/UX of FIG. 5B when displayed on a tablet in landscape mode.

This written description uses examples of the subject matter disclosed to enable any person skilled in the art to practice the same, including making and using any devices, systems, and/or non-transitory computer readable media, and/or performing any incorporated methods. The patentable scope of the subject matter is defined by the claims, and may include other examples that occur to those skilled in the art. Such other examples are intended to be within the scope of the claims.

What is claimed is:

1. A computing device comprising:
a memory storing computer readable instructions; and
processing circuitry configured to execute the computer readable instructions to cause the computing device to,
receive source code associated with a graphical user interface (GUI) for an application from at least one user, the received source code written in a first format,
translate the received source code into object elements of a second format using a parser,
generate a document object model (DOM) tree associated with the second format based on the object elements,
render the GUI of the application by processing the DOM tree using a execution environment associated with the application, and
display the rendered GUI on a display device.

2. The computing device of claim 1, wherein the processing circuitry is further configured to execute the computer readable instructions to cause the computing device to: receive updates to the source code from the at least one user;
update the rendering of the GUI of the application based on the received updates to the source code; and
display the updated rendering of the GUI of the application on the display device.

3. The computing device of claim 2, wherein the processing circuitry is further configured to execute the computer readable instructions to cause the computing device to:
perform the updating of the rendering of the GUI of the application in response to receiving the update to the source from the at least one user; and
display the updated rendering of the GUI of the application on the display device in response to completion of the updated rendering of the GUI.

4. The computing device of claim 1, wherein the processing circuitry is further configured to execute the computer readable instructions to cause the computing device to perform the translating of the received source code into the object elements by:
identifying web components included in the received source code, the identified web components written in a third format; and
translating the identified web components into the second format.

5. The computing device of claim 4, wherein the processing circuitry is further configured to execute the computer readable instructions to cause the computing device to:
traverse each object element included in the DOM tree, the traversing including,
determining whether each object element included in the DOM tree is a custom object element;
executing custom source code associated with the custom object element to generate a new native object element corresponding to the custom object element based on results of the determination, the custom source code written in the third format; and
adding the new native object element to the DOM tree.

6. The computing device of claim 1, wherein the execution environment is at least one of:
a software production environment, a software prototyping environment, a software development environment, a software testing environment, or any combinations thereof.

7. The computing device of claim 1, wherein the processing circuitry is further configured to execute the computer readable instructions to cause the computing device to:
display a software prototyping environment GUI associated with the first format in a first window of the display device; and
receive the source code from the at least one user via the software prototyping environment GUI.

8. The computing device of claim 7, wherein the processing circuitry is further configured to execute the computer readable instructions to cause the computing device to:
display the rendered GUI in a second window of the display device, wherein the first window and the second window are displayed on the display device simultaneously.

9. The computing device of claim 1, wherein the processing circuitry is further configured to execute the computer readable instructions to cause the computing device to:
perform an audit on the rendered GUI of the application, the audit including at least one of: a performance audit, an accessibility audit, a search engine optimization audit, or any combinations thereof.

10. The computing device of claim 1, wherein the processing circuitry is further configured to execute the computer readable instructions to cause the computing device to perform the rendering of the GUI of the application using a web browser in communication with the execution environment associated with the application.

11. A method of operating a computing device comprising:
receiving source code associated with a graphical user interface (GUI) for an application from at least one user, the received source code written in a first format;
translating the received source code into object elements of a second format using a parser;
generating a document object model (DOM) tree associated with the second format based on the object elements;
rendering the GUI of the application by processing the DOM tree using a execution environment associated with the application; and
displaying the rendered GUI on a display device.

12. The method of claim 11, further comprising:
receiving updates to the source code from the at least one user;
updating the rendering of the GUI of the application based on the received updates to the source code; and
displaying the updated rendering of the GUI of the application on the display device.

13. The method of claim 12, wherein
the rendering of the GUI of the application is updated in response to the receiving of the update to the source from the at least one user; and
the updated rendering of the GUI of the application is displayed on the display device in response to completion of the updated rendering of the GUI.

14. The method of claim 11, wherein the translating of the received source code into the object elements further includes:
identifying web components included in the received source code, the identified web components written in a third format;
translating the identified web components into the second format; and
adding additional object elements to the DOM tree corresponding to the identified web components based on the translation of the identified web components.

15. The method of claim 14, further comprising:
traversing each object element included in the DOM tree, the traversing including,
determining whether each object element included in the DOM tree is a custom object element;
executing custom source code associated with the custom object element to generate a new native object element corresponding to the custom object element based on results of the determination, the custom source code written in the third format; and
adding the new native object element to the DOM tree.

16. The method of claim 11, wherein the execution environment is at least one of:
a software production environment, a software prototyping environment, a software development environment, a software testing environment, or any combinations thereof.

17. The method of claim 11, further comprising:
displaying a software prototyping environment GUI associated with the first format in a first window of the display device; and
receiving the source code from the at least one user via the software prototyping environment GUI.

18. The method of claim 17, further comprising:
displaying the rendered GUI in a second window of the display device, wherein the first window and the second window are displayed on the display device simultaneously.

19. The method of claim 11, further comprising:
performing an audit on the rendered GUI of the application, the audit including at least one of: a performance audit, an accessibility audit, a search engine optimization audit, or any combinations thereof.

20. The method of claim 11, wherein the rendering of the GUI of the application is performed using a web browser in communication with the execution environment associated with the application.
